(19) United States
(12) Patent Application Publication
(10) Pub. No.: US 2024/0421712 A1
(43) Pub. Date: Dec. 19, 2024

(54) SWITCHING POWER SUPPLY DEVICE

(71) Applicant: TDK CORPORATION, Tokyo (JP)

(72) Inventor: Makoto SATO, Tokyo (JP)

(73) Assignee: TDK CORPORATION, Tokyo (JP)

(21) Appl. No.: 18/736,682

(22) Filed: Jun. 7, 2024

(30) Foreign Application Priority Data
Jun. 14, 2023 (JP) 2023-097886

(51) Int. Cl. H02M 3/335; H01F 3/14; H01F 27/28

(52) U.S. Cl. CPC H02M 3/335; H01F 3/14; H01F 27/28

(57) ABSTRACT

Provided is a switching power supply device in which coefficients of coupling a plurality of secondary windings to a primary winding of a transformer can be made equal, and current imbalance can be eliminated. The switching power supply device includes a planar type transformer, wherein a bridge, in which a plurality of switch elements are connected in series, and a primary winding is provided on a primary side of the transformer, and the switch elements include the switch elements controlled by a first on time, and the switch elements controlled by a second on time different from the first on time.

### CROSS-REFERENCE TO RELATED APPLICATION

Priority is claimed on Japanese Patent Application No. 2023-097886, filed Jun. 14, 2023, the content of which is incorporated herein by reference.

### BACKGROUND OF THE INVENTION

### Field of the Invention

The present disclosure relates to a switching power supply device.

### Description of Related Art

Switching power supply devices are used for power supply devices.

In Patent Document 1, attempts are made to make degrees of coupling when two secondary windings are coupled to one primary winding come closer to being equal to each other in a current resonant power supply transformer (see Patent Document 1). Patent Document 1 adopts a configuration in which an interlayer tape is interposed between a lead wire connected to a first secondary winding and a second secondary winding adjacent to the lead wire.

In Patent Document 1, for example, attempts are made to make the degrees of coupling when the two secondary windings are coupled to the one primary winding come closer to being equal to each other by utilizing a configuration of a thickness of the interlayer tape or the number of turns. Also, in Patent Document 1, for example, attempts are made to make the degrees of coupling when the two secondary windings are coupled to the one primary winding come closer to being equal to each other by adopting a configuration in which the primary winding is wound around outsides of the two secondary windings, and the interlayer tape is wound to pass through an outside of one secondary winding and through an inside of the other secondary winding.

In addition, in Patent Document 1, for example, attempts are made to make the degrees of coupling to the primary winding for height positions of each secondary winding come closer to being equal to each other by adopting a configuration in which the two secondary windings are alternately wound adjacent to the one primary winding.

### Patent Documents

[Patent Document 1] Japanese Unexamined Patent Application, First Publication No. 2017-126675

### SUMMARY OF THE INVENTION

However, in the known technology as described above, even if the degrees of coupling of each secondary winding are ideally the same, variations may occur in reality.

For example, in a center-tap half-bridge (HB)-LLC converter with two secondary windings on an output side thereof, variations may occur in L value or degree of coupling between the two secondary windings in some cases.

As a result of such variations, for example, the output current may also be biased, resulting in various disadvantages.

The present disclosure has been made in consideration of such circumstances, and an object thereof is to provide a switching power supply device in which coefficients of coupling a plurality of secondary windings to a primary winding of a transformer can be made equal, and current imbalance can be eliminated.

One aspect is a switching power supply device including a planar type transformer, wherein a bridge, in which a plurality of switch elements are connected in series, and a primary winding are provided on a primary side of the transformer, and the switch elements include the switch elements controlled by a first on time, and the switch elements controlled by a second on time different from the first on time.

According to the present disclosure, in the switching power supply device, coefficients of coupling the plurality of secondary windings to the primary winding of the transformer can be made equal, and current imbalance can be eliminated.

### BRIEF DESCRIPTION OF THE DRAWINGS

FIG. 1 is a diagram showing a configuration example of a circuit of a switching power supply device according to an embodiment.

FIG. 2 is a diagram showing a schematic configuration example of a planar transformer structure of windings in the switching power supply device according to the embodiment.

FIG. 3 is a diagram showing an example of a control voltage when a duty ratio is equal on a high side and a low side according to the embodiment.

FIG. 4 is a diagram showing an example of the control voltage when the high side is corrected according to the embodiment.

FIG. 5 is a diagram showing an example of the control voltage when the high side and low side are corrected according to the embodiment.

FIG. 6A is a diagram showing an example of currents flowing through two switching elements according to a comparative example.

FIG. 6B is a diagram showing an example of currents flowing through two diodes according to the comparative example.

FIG. 6C is a diagram showing an example of currents flowing through two switching elements according to the embodiment.

FIG. 6D is a diagram showing an example of currents flowing through two diodes according to the embodiment.

FIG. 7A is a diagram showing an example of the current flowing through the two switching elements according to the comparative example when a load current Io is 21 A.

FIG. 7B is a diagram showing an example of the current flowing through the two diodes according to the comparative example when the load current Io is 21 A.

FIG. 7C is a diagram showing an example of the current flowing through the two switching elements according to the embodiment when the load current Io is 21 A.

FIG. 7D is a diagram showing an example of the current flowing through the two diodes according to the embodiment when the load current Io is 21 A.

FIG. 8A is a diagram showing an example of the current flowing through the two switching elements according to the comparative example when the load current Io is 10 A.

FIG. 8B is a diagram showing an example of the current flowing through the two diodes according to the comparative example when the load current Io is 10 A.

FIG. 8C is a diagram showing an example of the current flowing through the two switching elements according to the embodiment when the load current Io is 10 A.

FIG. 8D is a diagram showing an example of the current flowing through the two diodes according to the embodiment when the load current Io is 10 A.

FIG. 9A is a diagram showing an example of the current flowing through the two switching elements according to the comparative example when the load current Io is 5 A.

FIG. 9B is a diagram showing an example of the current flowing through the two diodes according to the comparative example when the load current Io is 5 A.

FIG. 9C is a diagram showing an example of the current flowing through the two switching elements according to the embodiment when the load current Io is 5 A.

FIG. 9D is a diagram showing an example of the current flowing through the two diodes according to the embodiment when the load current Io is 5 A.

FIG. 10A is a diagram showing an example of the current flowing through the two switching elements according to the embodiment when an input voltage Vin is 400 V and fixed correction is used.

FIG. 10B is a diagram showing an example of the current flowing through the two diodes according to the embodiment when the input voltage Vin is 400 V and fixed correction is used.

FIG. 10C is a diagram showing an example of the current flowing through the two switching elements according to the embodiment when the input voltage Vin is 350 V and fixed correction is used.

FIG. 10D is a diagram showing an example of the current flowing through the two diodes according to the embodiment when the input voltage Vin is 350 V and fixed correction is used.

FIG. 10E is a diagram showing an example of the current flowing through the two switching elements according to the embodiment when the input voltage Vin is 300 V and fixed correction is used.

FIG. 10F is a diagram showing an example of the current flowing through the two diodes according to the embodiment when the input voltage Vin is 300 V and fixed correction is used.

FIG. 10G is a diagram showing an example of the current flowing through the two switching elements according to the embodiment when the input voltage Vin is 350 V and variable correction is used.

FIG. 10H is a diagram showing an example of the current flowing through the two diodes according to the embodiment when the input voltage Vin is 350 V and variable correction is used.

FIG. 10I is a diagram showing an example of the current flowing through the two switching elements according to the embodiment when the input voltage Vin is 300 V and variable correction is used.

FIG. 10J is a diagram showing an example of the current flowing through the two diodes according to the embodiment when the input voltage Vin is 300 V and variable correction is used.

FIG. 11 is a diagram showing an example of a variable correction table according to the embodiment.

### DETAILED DESCRIPTION OF THE INVENTION

An embodiment of the present disclosure will be described below with reference to the drawings.

### Switching Power Supply Device

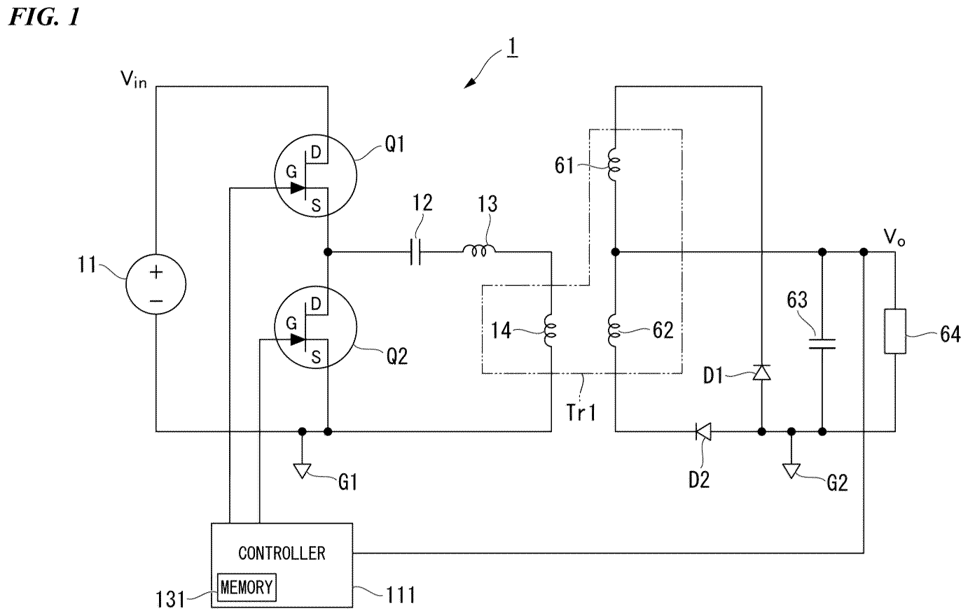

FIG. 1 is a diagram showing a configuration example of a circuit of a switching power supply device 1 according to an embodiment.

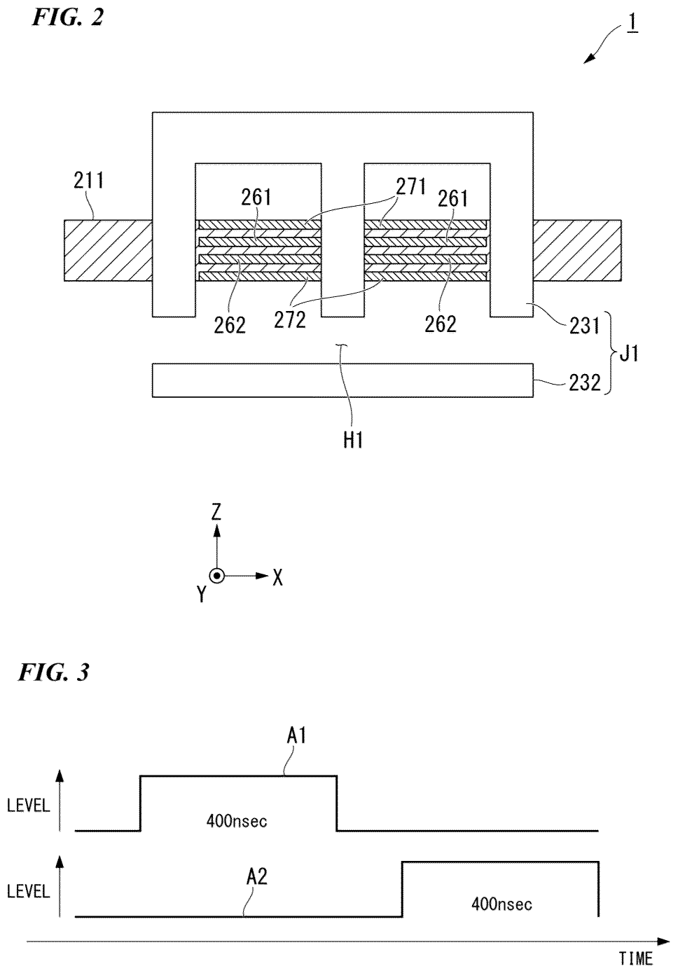

FIG. 2 is a diagram showing a schematic configuration example of a planar transformer structure of windings in the switching power supply device 1 according to the embodiment.

In the present embodiment, a switching power supply device 1 using a center-tap half-bridge (HB)-LLC converter is shown as an example.

### Example of Circuit of Switching Power Supply Device

The configuration example of the circuit of the switching power supply device 1 according to the present embodiment will be described with reference to FIG. 1.

The switching power supply device 1 includes a DC power supply 11, a transistor Q1, a transistor Q2, a capacitor 12, an inductor 13, one primary winding 14 constituting a transformer Tr1, a secondary winding 61 and a secondary winding 62, which are two secondary windings constituting the transformer Tr1, a diode D1, a diode D2, a capacitor 63, a load 64, and a controller 111.

The controller 111 has a memory 131.

Here, in the present embodiment, the transistor Q1 and the transistor Q2 are both field effect transistors (FETs), but may be other switching devices.

A connection relationship of the circuit will be described.

A positive (+) terminal of the DC power supply and a drain (D) terminal of the transistor Q1 are connected to each other.

In the present embodiment, a voltage at the positive (+) terminal of the DC power supply will be referred to as an input voltage Vin.

A source(S) terminal of the transistor Q1, a drain (D) terminal of the transistor Q2, and one end of the capacitor 12 are connected to each other.

The other end of the capacitor 12 and one end of the inductor 13 are connected to each other.

The other end of the inductor 13 and one end of the primary winding 14 are connected to each other.

A negative (−) terminal of the DC power supply, a source(S) terminal of the transistor Q2, and the other end of the primary winding 14 are connected to each other.

In the present embodiment, the negative (−) terminal of the DC power supply is connected to a ground portion G1 and is grounded.

One end of the secondary winding 62 and a cathode of the diode D2 are connected to each other.

The other end of the secondary winding 62, one end of the secondary winding 61, one end of the capacitor 63, and one end of the load 64 are connected to each other. The other end of the secondary winding 61 and a cathode of the diode DI are connected to each other.

An anode of the diode D1, an anode of the diode D2, the other end of the capacitor 63, and the other end of the load 64 are connected to each other.

In the present embodiment, the other end of the load 64 is connected to a ground portion G2 and is grounded.

Here, in the present embodiment, the ground portion G1 and the ground portion G2 have different ground potentials and are divided into a primary circuit and a secondary circuit.

The controller 111 is connected to a gate (G) terminal of the transistor Q1 and has a function of outputting (applying) a control voltage to the gate (G) terminal of the transistor Q1.

Also, the controller 111 is connected to a gate (G) terminal of the transistor Q2 and has a function of outputting (applying) a control voltage to the gate (G) terminal of the transistor Q2.

Further, the controller 111 is connected to one end of the load 64 and has a function of detecting a voltage at the connected position (referred to as an output voltage Vo in the present embodiment).

Here, the functions of the controller 111 may be configured using a microcomputer, for example.

In addition, in the present embodiment, the control voltage is a value that may change over time and has time and level (voltage) parameters. Also, the control voltage according to the present embodiment may be called a control signal, a voltage signal, a control voltage signal, or the like.

In the present embodiment, for convenience of description, the description will be made assuming that one transistor Q1 is a high side transistor and the other transistor Q2 is a low side transistor.

In the present embodiment, the controller 111 has a function of performing fixed correction control or variable correction control for the control voltages of the two transistors Q1 and Q2.

Here, the fixed correction control is control in which an amount of correction is fixed, and the variable correction control is control in which the amount of correction is varied in accordance with a predetermined index value.

### Example of Operation of Switching Power Supply Device

The controller 111 performs control of a primary side circuit to repeat a state in which the transistor Q1 is turned on and the transistor Q2 is turned off, a state in which both of the transistor Q1 and the transistor Q2 are turned off, a state in which the transistor Q1 is turned off and the transistor Q2 is turned on, and a state in which both of the transistor Q1 and the transistor Q2 are turned off.

Through this control, a predetermined current flows through the primary winding 14 of the transformer Tr1 in each state (mode), and a corresponding current flows through the two secondary windings 61 and 62, thereby obtaining a predetermined output voltage Vo.

Also, the controller 111 may, for example, detect the output voltage Vo and perform feedback control on the primary side in accordance with the detection result.

### Planar Transformer Structure

FIG. 2 is a diagram showing a schematic configuration example of the planar transformer structure of the windings in the switching power supply device 1 according to the embodiment.

FIG. 2 shows, for convenience of description, XYZ orthogonal coordinate axes, which are three-dimensional orthogonal coordinate axes. The example of FIG. 2 schematically shows an example of a state of a cross-section thereof in a side view when an E-shaped core member 231 and an I-shaped core member 232 are disposed to face each other in the vertical direction.

In the planar transformer structure according to the present embodiment, winding patterns 261 to 262 and 271 to 272 are printed on a printed circuit board 211. In addition, the printed circuit board 211 is combined with a core J1 to assemble a transformer.

In the example of FIG. 2, the core J1 is an EI type core. The core J1 is configured using a plurality of core members 231 and 232. An air gap H1 is provided between the core member 231 and the core member 232.

In the example shown in FIG. 2, the air gap H1 is asymmetrical in the vertical direction, which causes imbalance.

The one primary winding 14 is configured by the winding patterns 261 to 262. One of the secondary windings 61 is configured by the winding pattern 271.

The other secondary winding 62 is configured by the winding pattern 272.

In the present embodiment, the two secondary windings 61 and 62 are disposed at symmetrical positions with respect to the primary winding 14.

In addition, in the present embodiment, the two secondary windings 61 and 62 have the same configuration and, for example, the number of turns, the length of the electric wire, and the winding radius are the same.

Here, the planar transformer will be described.

A planar transformer is a transformer that is assembled by printing winding patterns on a printed circuit board and inserting a core thereinto. In a planar transformer, winding patterns are printed, and thus it has the advantage that there is less variation as compared to, for example, a transformer in which electric wires are actually wound.

Also, when electric wires are actually wound, there may be a tendency for variations, but variations occur due to random factors (for example, thicknesses of wires, lots, workers, and the like), making it difficult to determine the tendency. That is, in this case, a relationship (for example, a magnitude relationship) between L values (inductances) of two secondary windings is indefinite.

On the other hand, in general, a planar transformer tends to have design variations, but manufacturing variations are less likely to occur.

For this reason, when a planar transformer is used, it is possible to know in advance a relationship (for example, a magnitude relationship) between L values (inductances) of two secondary windings, and the L value (inductance) of either one of the secondary windings always becomes larger.

In the structure shown in FIG. 2, the two secondary windings 61 and 62 are produced symmetrically with respect to the one primary winding 14, and the structure is well balanced.

In addition, in the structure shown in FIG. 2, a position of the air gap H1 of the core J1 is biased, and thus, due to the influence of leakage flux generated there, the inductance of the secondary winding closer to the air gap H1 (in the example of FIG. 2, the secondary winding of the lower winding pattern 272) tends to be higher. That is, the L values of the secondary windings can vary depending on a position of the air gap, separately from printing of the winding patterns.

For example, the relationship (for example, the magnitude relationship) between the L values (inductances) of the two secondary windings may change depending on the position of the air gap H1.

In this way, in the planar transformer, variations tend to be biased in one direction, and it is easy to control the bias. For this reason, for example, it is possible to check the variations in advance and set the variations in duty in advance.

Such a control method is compatible with digital control, and for example, it is possible to set the amount by which the duty is unbalanced to a fixed value and to specify a correction mode (a correction value, and the like) using a program. Thus, for example, there is no loss or cost due to a detection function for variations, there is no need for control to change the correction mode, and it is possible to enjoy benefits of improvement of current imbalance.

In addition, in a planar transformer, for example, it is possible to reduce heights, reduce air gaps, and increase power density.

Here, in the present embodiment, a case in which the position of the air gap of the core is asymmetrical is shown, but in other examples, the position of the air gap of the core may be symmetrical, and as a specific example, in the example of FIG. 2, the air gap may be located at a center position in the vertical direction.

### Principle of Transformer

Here, the principle of a transformer will be described.

In principle, an output of a transformer is determined by a turn ratios of windings, but its characteristics change depending on a positional relationship of the windings.

For example, a ratio of a voltage V2 of a secondary winding to a voltage V1 of a primary winding is equal to a ratio of the number of turns N2 of the secondary winding to the number of turns N1 of the primary winding (V2/V1=N2/N1).

A product of the voltage V1 and a current I1 of the primary winding is equal to a product of the voltage V2 and a current I2 of the secondary winding (I1×V1=I2×V2).

In this way, the output of a transformer is determined by the turn ratios of the windings. This also applies when a plurality of secondary windings are provided.

In addition, the output on the secondary side changes depending on, for example, a positional relationship of the secondary windings with respect to the primary winding, a difference in lengths of electric wires, a winding radius, or the like.

Basically, when a plurality of secondary windings are provided, disadvantages may arise if the configuration of the plurality of secondary windings is unbalanced.

The disadvantages include, for example, reduced efficiency, reduced element margin, worsened output ripple noise, changed heat distribution, or increased costs to address these disadvantages.

Also, known transformers are often produced by manually winding electric wires. In this case, structural variations in the windings tended to increase. Specifically, for example, places at which electric wires overlap each other and gaps (intervals between electric wires) are often seen randomly, and this inability to control lengths and winding positions of the electric wires is a cause of variations.

### Duties of Two Transistors

Duties of the two transistors Q1 and Q2 will be described with reference to FIGS. 3 to 5. In the graphs shown in the examples of FIGS. 3 to 5, the horizontal axis represents time, and the vertical axis represents voltage level.

In the examples shown in FIGS. 3 to 5, the description will be made assuming that high levels (in the present embodiment, levels when they are turned on) and low levels (in the present embodiment, level when they are turned off) of the control voltages of the two transistors Q1 and Q2 are constant, but for example, the high level may change due to a change in on time.

FIG. 3 is a diagram showing an example of a control voltage when a duty ratio is equal on a high side and a low side according to the embodiment.

In the example of FIG. 3, a control voltage A1 is an example of the control voltage applied by the controller 111 as a gate-source voltage (Vgs) of the high side transistor Q1.

A control voltage A2 is an example of the control voltage applied by the controller 111 as the gate-source voltage (Vgs) of the low side transistor Q2.

In the example shown in FIG. 3, the control is performed to repeat a state in which both of the high side control voltage A1 and the low side control voltage A2 are off (predetermined low level voltages), a state in which the high side control voltage A1 is on (a predetermined high level voltage) and the low side control voltage A2 is off, a state in which the low side control voltage A2 is on and the high side control voltage A1 is off, and a state in which both the high side control voltage A1 and the low side control voltage A2 are off.

Here, a period during which the high side control voltage A1 remains on and a period during which the low side control voltage A2 remains on are both equal, for example, 400 [nsec]. In the present embodiment, such control voltages A1 and A2 can be controlled by the controller 111.

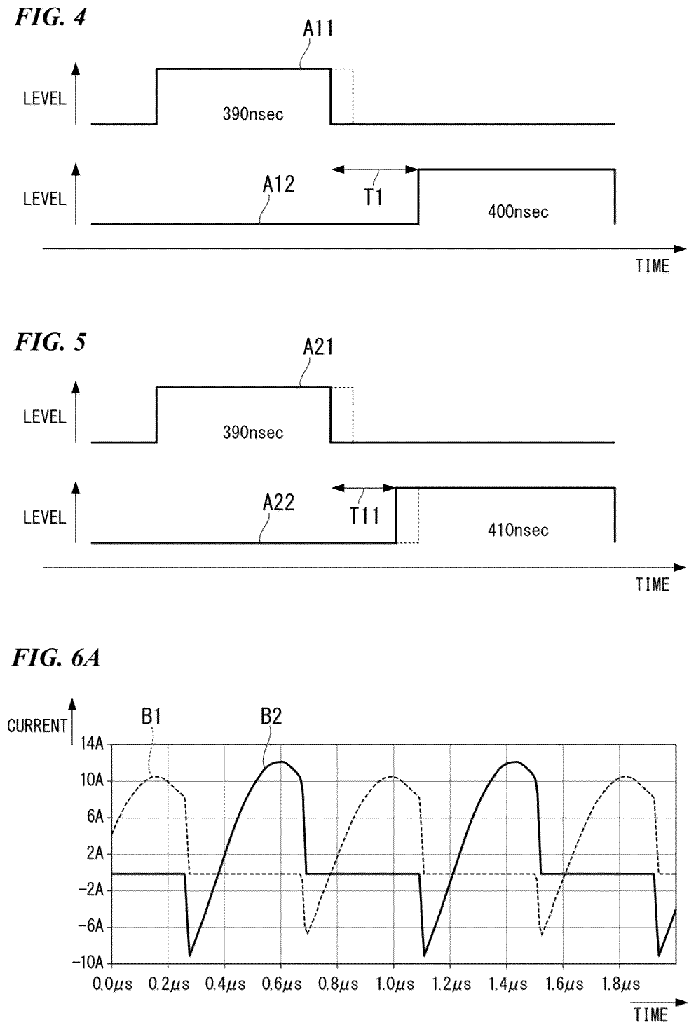

FIG. 4 is a diagram showing an example of the control voltage when the high side is corrected according to the embodiment. In this example, the duty ratio is different between the high side and the low side. In the example of FIG. 4, a control voltage A11 is an example of the control voltage applied by the controller 111 as the gate-source voltage (Vgs) of the high side transistor Q1.

A control voltage A12 is an example of the control voltage applied by the controller 111 as the gate-source voltage (Vgs) of the low side transistor Q2.

In the example of FIG. 4, the control is performed to repeat a state in which both of the high side control voltage A11 and the low side control voltage A12 are off (predetermined low level voltages), a state in which the high side control voltage A11 is on (a predetermined high level voltage) and the low side control voltage A12 is off, a state in which the low side control voltage A12 is on and the high side control voltage A11 is off, and a state in which both the high side control voltage A11 and the low side control voltage A12 are off.

Here, a period during which the high side control voltage A11 remains on and a period during which the low side control voltage A12 remains on are different from each other, and for example, they are 390 [nsec] and 400 [nsec], respectively.

In the present embodiment, such control voltages All and A12 can be controlled by the controller 111.

In the example of FIG. 4, as compared to the example of FIG. 3, a time T1 from when the high side control voltage A11 falls to when the low side control voltage A12 rises is set to be longer.

FIG. 5 is a diagram showing an example of the control voltage when the high side and low side are corrected according to the embodiment. In this example, the duty ratio is different between the high side and the low side.

In the example of FIG. 5, a control voltage A21 is an example of the control voltage applied by the controller 111 as the gate-source voltage (Vgs) of the high side transistor Q1.

A control voltage A22 is an example of the control voltage applied by the controller 111 as the gate-source voltage (Vgs) of the low side transistor Q2.

In the example of FIG. 5, the control is performed to repeat a state in which both of the high side control voltage A21 and the low side control voltage A22 are off (predetermined low level voltages), a state in which the high side control voltage A21 is on (a predetermined high level voltage) and the low side control voltage A22 is off, a state in which the low side control voltage A22 is on and the high side control voltage A21 is off, and a state in which both the high side control voltage A21 and the low side control voltage A22 are off.

Here, a period during which the high side control voltage A21 remains on and a period during which the low side control voltage A22 remains on are different from each other, and for example, they are 390 [nsec] and 410 [nsec], respectively.

In the present embodiment, such control voltages A21 and A22 can be controlled by the controller 111.

In the example of FIG. 5, as compared to the example of FIG. 4, a time T11 from when the high side control voltage A21 falls to when the low side control voltage A22 rises is shorter, and for example, the time is the same as in the example of FIG. 3.

Here, basically, in an LLC converter, as in the example in FIG. 3, a high side switch and a low side switch are turned on alternately with a duty of 50:50. On the other hand, in the present embodiment, imbalance of currents flowing through the two secondary windings 61 and 62 is resolved by unbalancing the duty, such as 49:51.

For example, a case is considered in which, when the high side switch and the low side switch are turned on alternately for 400 [nsec] with a duty of 50:50, as a result of observing the current in the secondary windings, more current flows during the period when the low side is on than during the period when the high side is on. In order to resolve this situation, in the present embodiment, the control is intentionally performed to disrupt the duty balance between the high side and the low side.

As such an aspect of the control, for example, an aspect may be used in which the on time is shortened only on the high side as in the example of FIG. 4, an aspect may be used in which the on time is extended only on the low side, or an aspect may be used in which the low side on time and the high side on time are simultaneously increased or decreased as in the example of FIG. 5. In these aspects, for example, similar effects can be obtained.

Here, the case in which more current flows during the period when the low side is on than during the period when the high side is on has been described, but conversely, when more current flows during the period when the high side is on than during the period when the low side is on, an aspect in which the on time is shortened only on the low side, an aspect in which the on time is extended only on the high side, or an aspect in which the high side on time and the low side on time are simultaneously increased or decreased may be used.

In this way, in the present embodiment, in the case of an LLC converter (LLC resonant converter), correction is made to shorten an on width of one of the high side and the low side through which less current flows.

Also, strictly speaking, if the on time of one switch is shortened, a dead time or frequency will change. In order to prevent occurrence of this, an aspect may be used in which on times of both switches are increased or decreased.

For example, in the example shown in FIG. 4, the on time is shortened only on the high side, and the dead time appears to be extended. In this case, if the dead time is shortened by that amount, the period (˜frequency) will change.

In the following specific examples, for convenience of description, a case in which an aspect is used in which the on times of both switches are increased or decreased will be described as an example.

### Balance of Currents Flowing Through Two Diodes

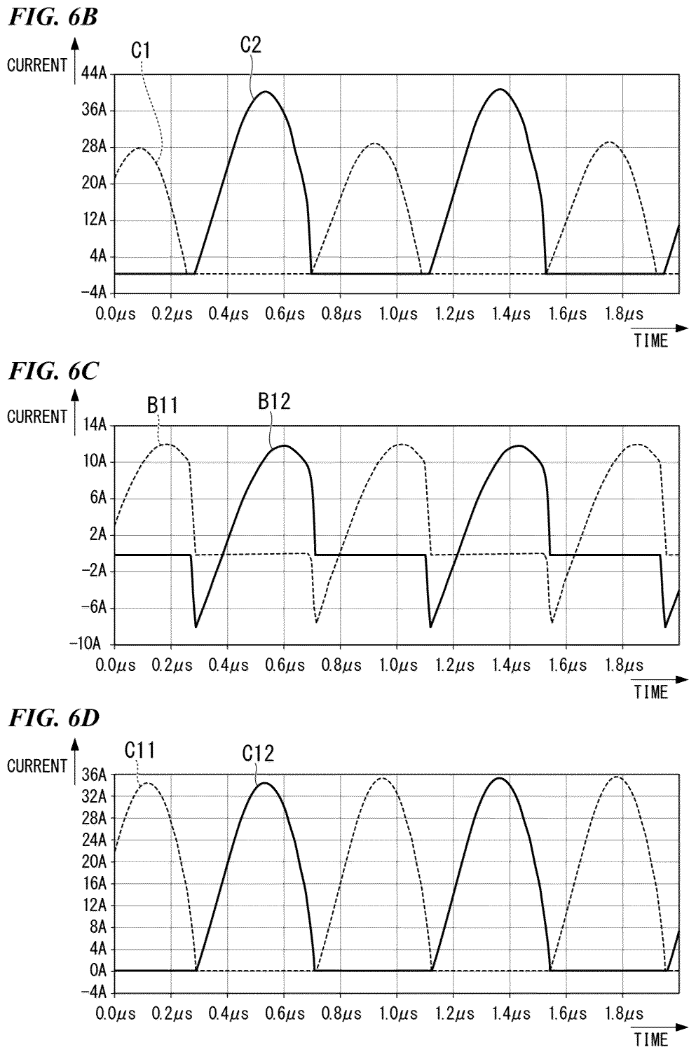

The balance of currents flowing through two diodes will be described with reference to FIGS. 6A to 6D. Here, the two diodes correspond to two diodes D1 and D2 in the present embodiment.

In the graphs shown in the examples of FIGS. 6A to 6D, the horizontal axis represents time, and the vertical axis represents current value.

FIG. 6A is a diagram showing an example of currents flowing through two switching elements according to a comparative example. Here, the two switching elements correspond to the two transistors (transistors Q1 and Q2) in the present embodiment.

FIG. 6A shows a current B1 flowing through a drain of one transistor and a current B2 flowing through a drain of the other transistor.

FIG. 6B is a diagram showing an example of currents flowing through the two diodes according to the comparative example.

FIG. 6B shows a current C1 flowing through one diode and a current C2 flowing through the other diode.

In the examples of FIGS. 6A and 6B, values of the currents C1 and C2 flowing through the two diodes are different from each other, resulting in an unbalanced state.

On the other hand, in the present embodiment, the controller 111 performs control to make levels of the control voltages of the two transistors Q1 and Q2 different from each other, as in the example of FIG. 5. Through such control, in the present embodiment, it is possible to inhibit imbalance in the values of the currents flowing through the two diodes D1 and D2, and to balance them.

FIG. 6C is a diagram showing an example of currents flowing through the two switching elements (transistors Q1 and Q2) according to the embodiment.

FIG. 6C shows a current B11 flowing through the drain of one transistor Q1 and a current B12 flowing through the drain of the other transistor Q2.

FIG. 6D is a diagram showing an example of currents flowing through the two diodes D1 and D2 according to the embodiment.

FIG. 6D shows a current C11 flowing through one diode D1 and a current C12 flowing through the other diode D2.

In the examples of FIGS. 6C and 6D, values of the currents C11 and C12 flowing through the two diodes D1 and D2 are the same (or almost the same).

### Load Dependence

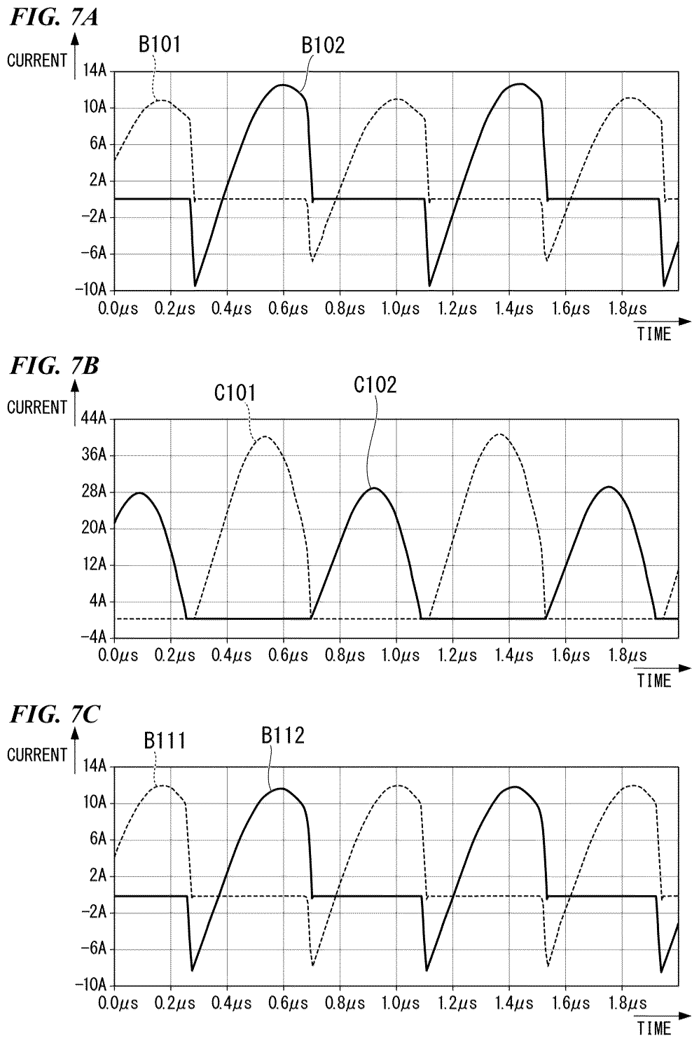

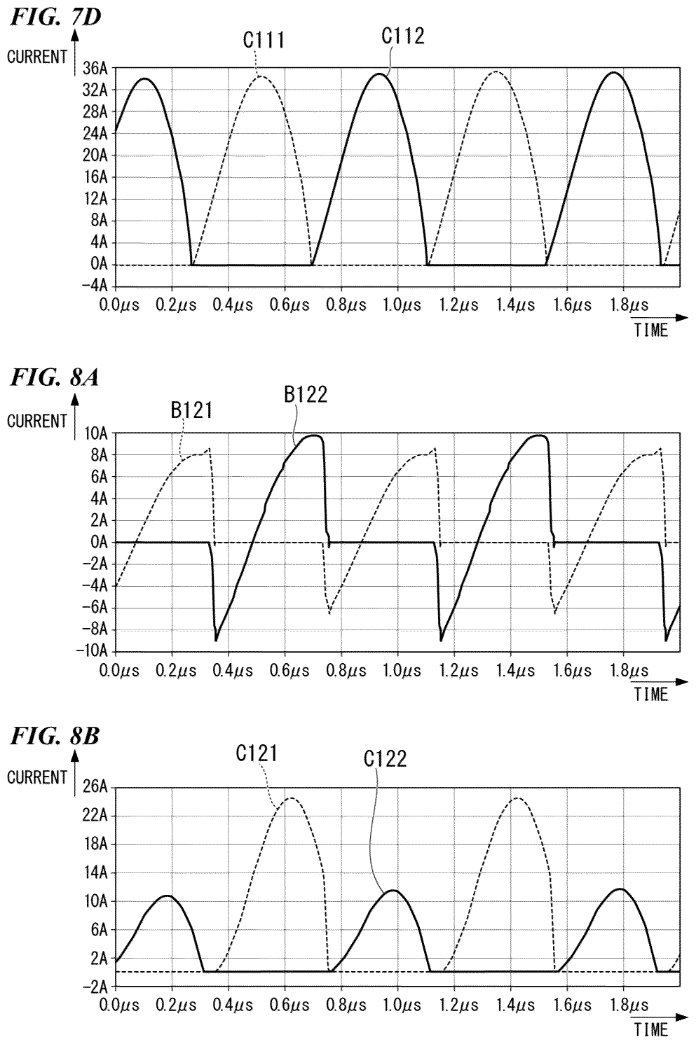

Load dependence will be described with reference to FIGS. 7A to 7D, FIGS. 8A to 8D, and FIGS. 9A to 9D. Also, in the present embodiment, due to a frequency modulation method in the LLC converter, when a load changes, a frequency (switching frequency) may also change.

In the graphs shown in FIGS. 7A to 7D, FIGS. 8A to 8D, and FIGS. 9A to 9D, the horizontal axis represents time, and the vertical axis represents current value.

### Example when load current Io=21 [A]

With reference to FIGS. 7A to 7D, a case will be described in which the frequency (switching frequency) of the LLC converter is 1.2 [MHz], an output voltage Vo=48 [V], and a load current Io=21 [A].

FIG. 7A is a diagram showing an example of currents flowing through two switching elements according to the comparative example when the load current Io is 21 A.

Here, the two switching elements correspond to two transistors (transistors Q1 and Q2) in the present embodiment.

FIG. 7A shows a current B101 flowing through the drain of one transistor and a current B102 flowing through the drain of the other transistor.

FIG. 7B is a diagram showing an example of currents flowing through two diodes according to the comparative example when the load current Io is 21 A.

Here, the two diodes correspond to the two diodes D1 and D2 in the present embodiment.

FIG. 7B shows a current C101 flowing through one diode and a current C102 flowing through the other diode.

In the examples of FIGS. 7A and 7B, values of the currents C101 and C102 flowing through the two diodes are different from each other, resulting in an unbalanced state.

Here, in the examples of FIGS. 7A and 7B, lengths (duty ratios) of on periods of the control voltages of the two transistors are the same, as in the example of FIG. 3.

On the other hand, in the present embodiment, the controller 111 performs control to vary lengths of on periods (duty ratios) of the control voltages of the two transistors Q1 and Q2, as in the example of FIG. 5. Through such control, in the present embodiment, it is possible to inhibit imbalance in the values of the currents flowing through the two diodes D1 and D2, and to balance them.

FIG. 7C is a diagram showing an example of currents flowing through the two switching elements (transistors Q1 and Q2) according to the embodiment when the load current Io is 21 A.

FIG. 7C shows a current B111 flowing through the drain of one transistor Q1 and a current B112 flowing through the drain of the other transistor Q2.

FIG. 7D is a diagram showing an example of currents flowing through the two diodes D1 and D2 according to the embodiment when the load current Io is 21 A.

FIG. 7D shows a current C111 flowing through one diode D1 and a current C112 flowing through the other diode D2.

In the examples of FIGS. 7C and 7D, values of the currents C111 and C112 flowing through the two diodes D1 and D2 are the same (or almost the same).

Here, in the examples of FIGS. 7C and 7D, a period during which the high side control voltage remains on is set to −10 [nsec], that is, 10 [nsec] shorter, and a period during which the low side control voltage remains on is set to +10 [nsec], that is, 10 [nsec] longer.

### Example when Load Current Io=10 [A]

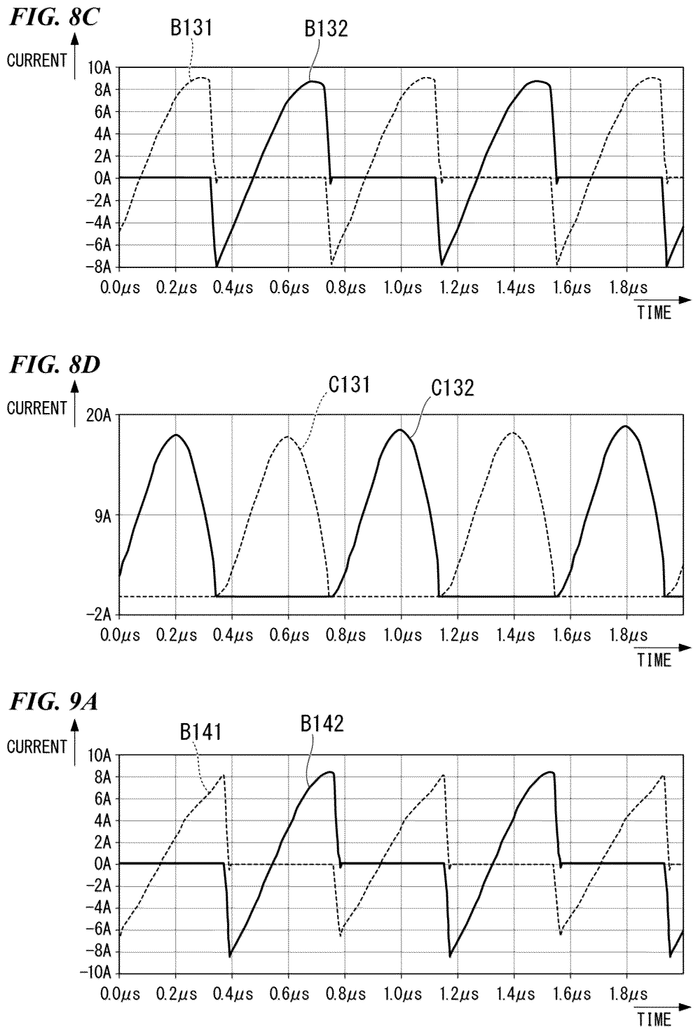

With reference to FIGS. 8A to 8D, a case will be described in which the frequency (switching frequency) of the LLC converter is 1.25 [MHz], the output voltage Vo=48 [V], and the load current Io =10 [A].

FIG. 8A is a diagram showing an example of currents flowing through two switching elements according to the comparative example when the load current Io is 10 A.

Here, the two switching elements correspond to the two transistors (transistors Q1 and Q2) in the present embodiment.

FIG. 8A shows a current B121 flowing through the drain of one transistor and a current B122 flowing through the drain of the other transistor.

FIG. 8B is a diagram showing an example of currents flowing through two diodes according to the comparative example when the load current Io is 10 A. Here, the two diodes correspond to the two diodes D1 and D2 in the present embodiment.

FIG. 8B shows a current C121 flowing through one diode and a current C122 flowing through the other diode.

In the examples of FIGS. 8A and 8B, values of the currents C121 and C122 flowing through the two diodes are different from each other, resulting in an unbalanced state.

Here, in the examples of FIGS. 8A and 8B, the on period lengths (duty ratios) of the control voltages of the two transistors are the same as in the example of FIG. 3.

On the other hand, in the present embodiment, as in the example of FIG. 5, the controller 111 performs control to vary the lengths of on periods (duty ratios) of the control voltages of the two transistors Q1 and Q2. Through such control, in the present embodiment, it is possible to inhibit the imbalance in the values of the currents flowing through the two diodes D1 and D2, and to balance them.

FIG. 8C is a diagram showing an example of currents flowing through the two switching elements (transistors Q1 and Q2) according to the embodiment when the load current Io is 10 A.

FIG. 8C shows a current B131 flowing through the drain of one transistor Q1 and a current B132 flowing through the drain of the other transistor Q2.

FIG. 8D is a diagram showing an example of currents flowing through the two diodes D1 and D2 according to the embodiment when the load current Io is 10 A.

FIG. 8D shows a current C131 flowing through one diode D1 and a current C132 flowing through the other diode D2.

In the examples of FIGS. 8C and 8D, values of the currents C131 and C132 flowing through the two diodes D1 and D2 are the same (or almost the same).

Here, in the examples of FIGS. 8C and 8D, a period during which the high side control voltage remains on is set to −10 [nsec], that is, 10 [nsec] shorter, and a period during which the low side control voltage remains on is set to +10 [nsec], that is, 10 [nsec] longer.

### Example when Load Current Io=5 [A]

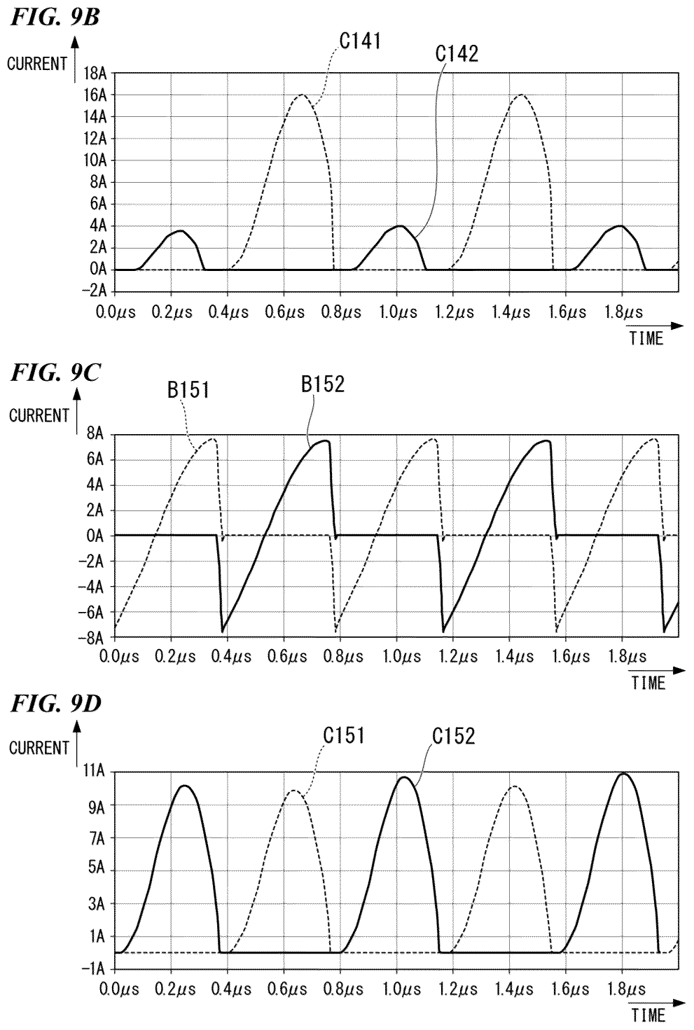

With reference to FIGS. 9A to 9D, a case will be described in which the frequency (switching frequency) of the LLC converter is 1.28 [MHz], the output voltage Vo=48 [V], and the load current Io=5 [A].

FIG. 9A is a diagram showing an example of currents flowing through two switching elements according to the comparative example when the load current Io is 5 A.

Here, the two switching elements correspond to the two transistors (transistors Q1 and Q2) in the present embodiment.

FIG. 9A shows a current B141 flowing through the drain of one transistor and a current B142 flowing through the drain of the other transistor.

FIG. 9B is a diagram showing an example of currents flowing through two diodes according to the comparative example when the load current Io is 5 A.

Here, the two diodes correspond to two diodes D1 and D2 in the present embodiment.

FIG. 9B shows a current C141 flowing through one diode and a current C142 flowing through the other diode.

In the examples of FIGS. 9A and 9B, values of the currents C141 and C142 flowing through the two diodes are different from each other, resulting in an unbalanced state.

Here, in the examples of FIGS. 9A and 9B, the lengths (duty ratios) of the on periods of the control voltages of the two transistors are the same as in the example of FIG. 3.

On the other hand, in the present embodiment, as in the example of FIG. 5, the controller 111 performs control to vary the lengths of on periods (duty ratios) of the control voltages of the two transistors Q1 and Q2. Through such control, in the present embodiment, it is possible to inhibit the imbalance in the values of the currents flowing through the two diodes D1 and D2, and to balance them.

FIG. 9C is a diagram showing an example of currents flowing through the two switching elements (transistors Q1 and Q2) according to the embodiment when the load current Io is 5 A.

FIG. 9C shows a current B151 flowing through the drain of one transistor Q1 and a current B152 flowing through the drain of the other transistor Q2.

FIG. 9D is a diagram showing an example of currents flowing through the two diodes D1 and D2 according to the embodiment when the load current Io is 5 A.

FIG. 9D shows a current C151 flowing through one diode D1 and a current C152 flowing through the other diode D2.

In the examples of FIGS. 9C and 9D, values of the currents C151 and C152 flowing between the two diodes D1 and D2 are the same (or approximately the same).

Here, in the examples of FIGS. 9C and 9D, a period during which the high side control voltage remains on is set to −10 [nsec], that is, 10 [nsec] shorter, and a period during which the low side control voltage remains on is set to +10 [nsec], that is, 10 [nsec] longer.

In the above examples of FIGS. 7A to 7D, 8A to 8D, and 9A to 9D, even in a case in which the load changes, it is possible to eliminate the current imbalance by making the correction mode of the high side and low side control voltages (the amount of correction of the on time) the same. That is, in this example, it can be said that the correction mode has no (or little) load dependence, and a fixed correction may be applied to a plurality of loads.

Also, as another example, control may be performed in which the correction mode has load dependence.

### Input Voltage Dependence

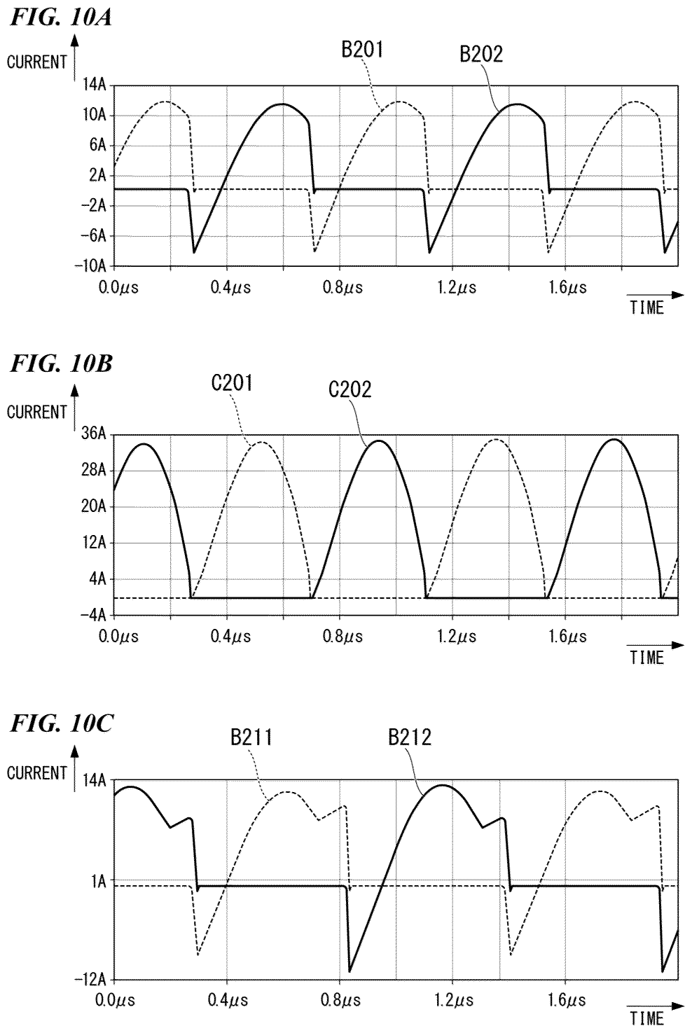

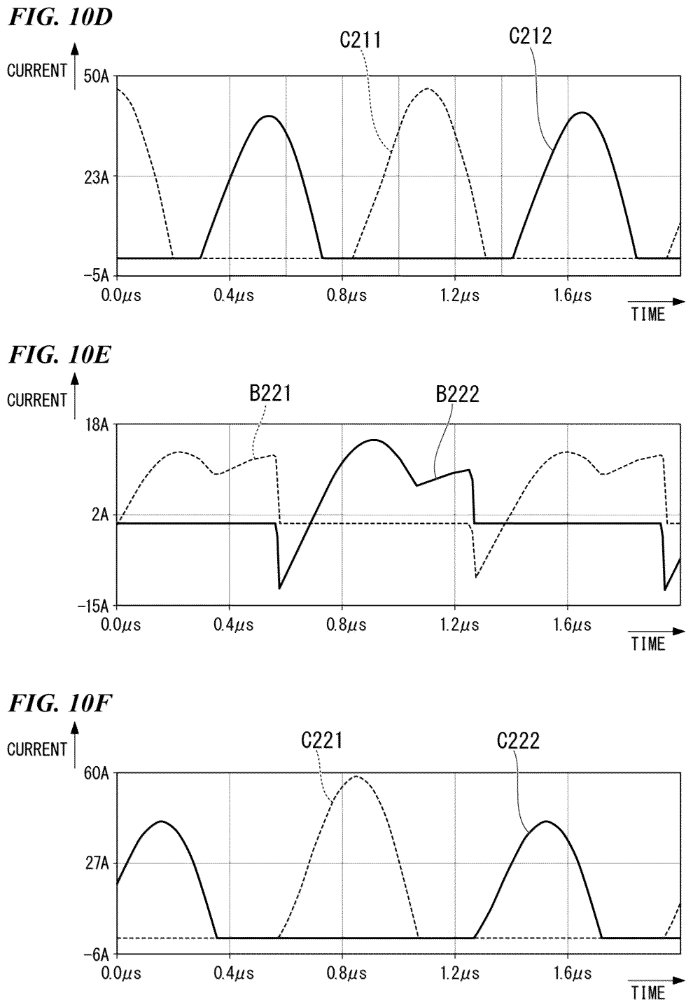

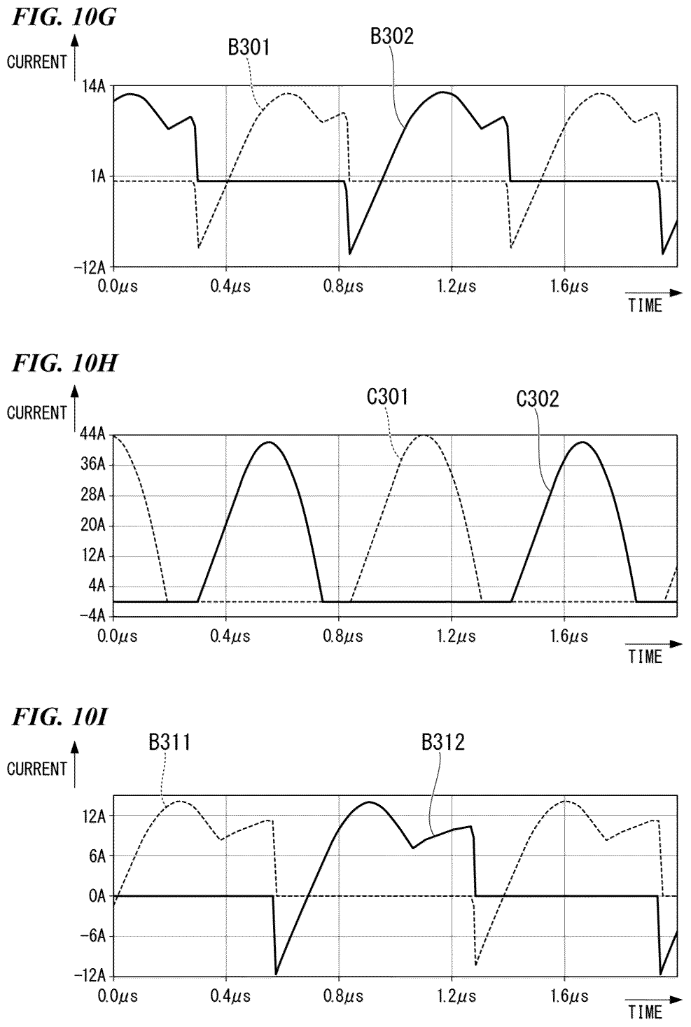

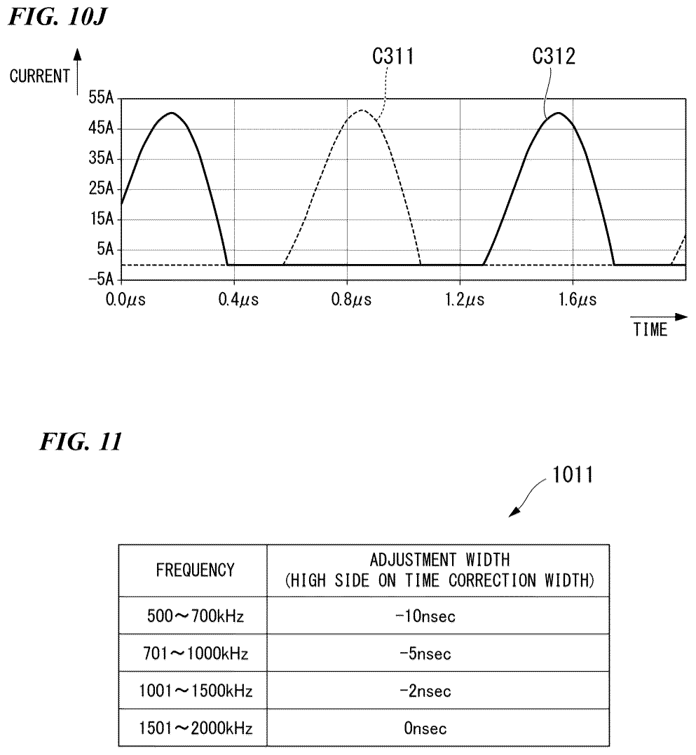

Input voltage dependence will be described with reference to FIGS. 10A to 10J. Also, in the present embodiment, due to the frequency modulation method in the LLC converter, when the input voltage changes, the frequency (switching frequency) may also change. In the graphs shown in FIGS. 10A to 10J, the horizontal axis represents time, and the vertical axis represents current value.

First, with reference to FIGS. 10A to 10F, a case will be shown in which an amount of correction for the on or off period of the control voltages of the two transistors Q1 and Q2 (the amount of correction of the duty ratio) is fixed.

In the example of FIGS. 10A to 10F, a period during which the high side control voltage remains on is set to −10 [nsec], that is, 10 [nsec] shorter, and a period during which the low side control voltage remains on is set to +10 [nsec], that is, 10 [nsec] longer.

### Example when Input Voltage Vin=400 [V]

With reference to FIGS. 10A and 10B, a case in which the frequency (switching frequency) of the LLC converter is 1.2 [MHz] and the input voltage Vin=400 [V] will be described.

FIG. 10A is a diagram showing an example of currents flowing through the two switching elements (transistors Q1 and Q2) according to the embodiment when the input voltage Vin is 400 V and fixed correction is used.

FIG. 10A shows a current B201 flowing through the drain of one transistor Q1 and a current B202 flowing through the drain of the other transistor Q2.

FIG. 10B is a diagram showing an example of currents flowing through the two diodes D1 and D2 according to the embodiment when the input voltage Vin is 400 V and fixed correction is used.

FIG. 10B shows a current C201 flowing through one diode D1 and a current C202 flowing through the other diode D2.

In the examples of FIGS. 10A and 10B, values of the currents C201 and C202 flowing through the two diodes D1 and D2 are the same (or almost the same).

### Example when Input Voltage Vin=350 [V]

With reference to FIGS. 10C to 10D, a case in which the frequency (switching frequency) of the LLC converter is 0.9 [MHz] and the input voltage Vin=350 [V] will be described.

FIG. 10C is a diagram showing an example of currents flowing through the two switching elements (transistors Q1 and Q2) according to the embodiment when the input voltage Vin is 350 V and fixed correction is used.

FIG. 10C shows a current B211 flowing through the drain of one transistor Q1 and a current B212 flowing through the drain of the other transistor Q2.

FIG. 10D is a diagram showing an example of currents flowing through the two diodes D1 and D2 according to the embodiment when the input voltage Vin is 350 V and fixed correction is used.

FIG. 10D shows a current C211 flowing through one diode D1 and a current C212 flowing through the other diode D2.

In the examples of FIGS. 10C and 10D, values of currents C211 and C212 flowing through the two diodes D1 and D2 are different from each other. That is, in the examples of FIGS. 10C and 10D, even if the control voltages of the transistors Q1 and Q2 are corrected in the same manner as in the cases of FIGS. 10A and 10B, it is not possible to sufficiently inhibit imbalance in the values of the currents flowing through the two diodes D1 and D2.

### Example when Input Voltage Vin=300 [V]

With reference to FIGS. 10E to 10F, a case in which the frequency (switching frequency) of the LLC converter is 0.73 [MHz] and the input voltage Vin=300 [V] will be described.

FIG. 10E is a diagram showing an example of currents flowing through the two switching elements (transistors Q1 and Q2) according to the embodiment when the input voltage Vin is 300 V and fixed correction is used.

FIG. 10E shows a current B221 flowing through the drain of one transistor Q1 and a current B222 flowing through the drain of the other transistor Q2.

FIG. 10F is a diagram showing an example of currents flowing through the two diodes D1 and D2 according to the embodiment when the input voltage Vin is 300 V and fixed correction is used.

FIG. 10F shows a current C221 flowing through one diode D1 and a current C222 flowing through the other diode D2.

In the examples of FIGS. 10E and 10F, values of currents C221 and C222 flowing through the two diodes D1 and D2 are different from each other. That is, in the examples of FIGS. 10E and 10F, even if the control voltages of the transistors Q1 and Q2 are corrected in the same manner as in the case of FIGS. 10A and 10B, it is not possible to sufficiently inhibit the imbalance in the values of the currents flowing through the two diodes D1 and D2.

Here, in the examples of FIGS. 10C and 10D and the examples of FIGS. 10E and 10F, a case in which the amount of correction for the on or off period of the control voltages of the two transistors Q1 and Q2 (the amount of correction of the duty ratio) is fixed and made the same (in the case of fixed correction) as compared to the examples of FIGS. 10A and 10B has been described.

On the other hand, a case (in the case of variable correction) in which the amount of correction of the on or off period of the control voltages of the two transistors Q1 and Q2 (the amount of correction of the duty ratio) is changed in accordance with the input voltage will be described. In the present embodiment, the controller 111 can control the imbalance in the values of the currents flowing through the two diodes D1 and D2 and balance them through such control.

### Example when Input Voltage Vin=350 [V]

With reference to FIGS. 10G to 10H, a case in which the frequency (switching frequency) of the LLC converter is 0.9 [MHz] and the input voltage Vin=350 [V] will be described.

FIG. 10G is a diagram showing an example of currents flowing through the two switching elements (transistors Q1 and Q2) according to the embodiment when the input voltage Vin is 350 V and variable correction is used.

FIG. 10G shows a current B301 flowing through the drain of one transistor Q1 and a current B302 flowing through the drain of the other transistor Q2.

FIG. 10H is a diagram showing an example of currents flowing through the two diodes D1 and D2 according to the embodiment when the input voltage Vin is 350 V and variable correction is used.

FIG. 10H shows a current C301 flowing through one diode D1 and a current C302 flowing through the other diode D2.

In the examples of FIGS. 10G and 10H, values of the currents C301 and C302 flowing through the two diodes D1 and D2 are the same (or almost the same).

Here, in the examples of FIGS. 10G and 10H, a period during which the high side control voltage remains on is set to −20 [nsec], that is, 20 [nsec] shorter, and a period during which the low side control voltage remains on is set to +20 [nsec], that is, 20 [nsec] longer.

### Example When Input Voltage Vin=300 [V]

With reference to FIGS. 10I to 10J, a case in which the frequency (switching frequency) of the LLC converter is 0.73 [MHz] and the input voltage Vin=300 [V] will be described.

FIG. 10I is a diagram showing an example of currents flowing through the two switching elements (transistors Q1 and Q2) according to the embodiment when the input voltage Vin is 300 V and variable correction is used.

FIG. 10I shows a current B311 flowing through the drain of one transistor Q1 and a current B312 flowing through the drain of the other transistor Q2.

FIG. 10J is a diagram showing an example of currents flowing through the two diodes D1 and D2 according to the embodiment when the input voltage Vin is 300 V and variable correction is used.

FIG. 10J shows a current C311 flowing through one diode D1 and a current C312 flowing through the other diode D2.

In the examples of FIGS. 10I and 10J, values of the currents C311 and C312 flowing through the two diodes D1 and D2 are the same (or almost the same).

Here, in the examples of FIGS. 101 and 10J, a period during which the high side control voltage remains on is set to −25 [nsec], that is, 25 [nsec] shorter, and a period during which the low side control voltage remains on is set to +25 [nsec], that is, 25 [nsec] longer.

In the above examples of FIGS. 10A to 10J, when the input voltage changes, it is possible to eliminate the current imbalance by changing the correction mode (amount of correction of the on time) of the high side and low side control voltages. That is, in this example, it can be said that the correction mode has input voltage dependence, and variable correction may be applied to a plurality of input voltages.

Also, as another example, the control in which the correction mode does not have input voltage dependence may be performed.

### Control of Fixed Correction and Variable Correction by Controller

### Fixed Correction

In the fixed correction, the controller 111 performs on or off control of the control voltages of the two transistors Q1 and Q2 by always setting the same amount of correction for the on or off period of the control voltages (the amount of correction of the duty ratio).

Also, for example, the amount of correction may be set in advance when the switching power supply device 1 is shipped, or may be fixed after the product is shipped.

### Variable Correction

In the variable correction, the controller 111 performs on or off control of the control voltages by changing the amount of correction of the on or off period of the control voltages of the two transistors Q1 and Q2 (the amount of correction of the duty ratio) in accordance with a predetermined index value.

Also, the correspondence between the index value and the amount of correction may be set in advance when the switching power supply device 1 is shipped, or may be fixed after the product is shipped.

Such a correspondence may be stored in the memory 131 of the controller 111, for example.

Here, as the index value, various values may be used, and for example, input voltages, frequency (switching frequency), loads, or the like may be used.

As the index value, for example, an index value may be used in which, when the index value changes, if it is fixed with the same correction value, it is not possible to sufficiently inhibit the imbalance in the values of the currents flowing through the two diodes D1 and D2.

The controller 111 has a function of acquiring a predetermined index value.

As an example, when a value set by itself (the controller 111) is used as the index value, the controller 111 acquires that value.

As another example, the controller 111 may obtain a result of detecting a predetermined index value by itself (controller 111) or by an external circuit. Here, the circuit for detecting the index value may be arbitrarily configured.

The controller 111 obtains the amount of correction corresponding to the obtained index value on the basis of the correspondence between the index value and the amount of correction. Then, the controller 111 corrects the on or off period of the control voltages of the two transistors Q1 and Q2 from a reference value using the obtained amount of correction and performs on or off control of the control voltages.

The reference value is, for example, a value when the on and off periods of the two transistors Q1 and Q2 are the same, as shown in FIG. 3, but values for other cases may also be used.

### Variable Correction Table

FIG. 11 is a diagram showing an example of a variable correction table 1011 according to the embodiment.

The variable correction table 1011 is an example of the correspondence between the index value and the amount of correction.

In the example of FIG. 11, frequency is used as the index value.

Also, the variable correction table 1011 may be called a map instead of a table, for example.

The variable correction table 1011 stores a relationship between the frequency (switching frequency) corresponding to the index value and an adjustment width (high side on time correction width) corresponding to the amount of correction. In the example of FIG. 11, the frequency corresponding to the index value is defined using a frequency width.

Specifically, the adjustment width is −10 [nsec] when the frequency is 500 to 700 kHz, the adjustment width is −5 [nsec] when the frequency is 701 to 1000 kHz, the adjustment width is −2 [nsec] when the wave number is 1001 to 1500 kHz, and the adjustment width is 0 [nsec] when the frequency is 1501 to 2000 KHz.

Here, the adjustment width of −10 [nsec] indicates that the high side on time is shortened by 10 [nsec], and the same applies to other adjustment widths.

Also, a plurality of adjustment widths may include a case in which no adjustment (correction) is performed. In the example of FIG. 11, the adjustment width of 0 [nsec] indicates that no adjustment (correction) is made to the reference value.

Here, a configuration that performs variable correction using the table (map) as shown in FIG. 11 is suitable for combination with a configuration that uses digital control (a digital controller), for example.

In general, the output of an LLC converter is controlled by frequency modulation. For this reason, for example, by storing a correction table (for example, a duty bias map) inside the controller according to conditions such as frequency, output voltages, or loads, it is possible to obtain a more detailed balance improvement effect.

As described above, in the switching power supply device 1 according to the present embodiment, coefficients of coupling the two secondary windings 61 and 62 to the primary winding 14 of the transformer Tr1 can be made equal, and current imbalance can be eliminated.

In the switching power supply device 1 according to the present embodiment, various advantages can be obtained, such as allowing improvement of the current imbalance resulting from variations in the secondary side inductance of the transformer Tr1 and balancing the energy output from the secondary windings 61 and 62, thereby improving efficiency and improving performance.

In the switching power supply device 1 according to the present embodiment, by using different on-times for each primary side bridge, it is possible to obtain current balance between the secondary windings 61 and 62 having a secondary side center tap configuration.

In the switching power supply device 1 according to the present embodiment, for example, by performing fixed correction or variable correction control that unbalances the duties of the two transistors Q1 and Q2 in a predetermined manner, it is possible to eliminate the need for other additional circuits and other controls.

Here, in the present embodiment, the problems that arise in the structure of the transformer are solved by the method of control.

In addition, in the present embodiment, problems that arise in the structure of the transformer are solved by reducing costs and labors.

Here, in the present embodiment, the configuration in which two windings (secondary windings) are disposed on the secondary side for one winding (primary winding) on the primary side has been shown, but as another example, a configuration in which three or more windings (secondary windings) are disposed on the secondary side for one winding (primary winding) on the primary side may be used.

In addition, the number of turns of these plurality of secondary windings may be the same.

Also, in the present embodiment, the configuration in which both of the high side and low side on periods are controlled as in the example of FIG. 5 has been shown, but as another example, as in the example of FIG. 4, a configuration in which the on period of any one of the high side and the low side is controlled may be used.

Also, in the present embodiment, as in the example of FIG. 5, the configuration in which the control is performed in consideration of dead time has been shown, but as another example, as in the example of FIG. 4, a configuration in which the control is performed without considering dead time may be used.

Also, in the present embodiment, the configuration in which the half-bridge circuit (the circuit using the two transistors Q1 and Q2) is provided on the primary side of the switching power supply device 1 has been shown, but as another example, a configuration in which a full-bridge (for example, four transistors) circuit is provided may be used.

Also, in the present embodiment, the configuration in which a center tap method is used on the secondary side of the switching power supply device 1 has been shown, but as another example, a configuration other than the center tap method may be used.

Further, in the present embodiment, for example, the correction may be performed using digital control or the correction may be performed using analog control.

Also, in the present embodiment, for example, any number of legs of the transformer may be used, and three, four, or five legs may be used.

Here, the leg is a part of the core and represents a part that penetrates a substrate.

Also, as setting of resonance inductance, for example, there is a case of using an external inductance or using a small leakage inductance.

For example, the switching power supply device 1 according to the present embodiment has a structure in which a resonant inductor and a transformer are integrated, and basically no external inductance is required.

Also, a program for realizing the function of any component (for example, the controller 111) in any device described above may be recorded on a computer-readable recording medium, and the program may be read and executed by a computer system. In addition, “computer system” herein includes an operating system or hardware such as peripheral equipment. Also, “computer-readable recording medium” indicates a portable medium such as a flexible disk, a magneto-optical disk, a ROM, a compact disc (CD)-read only memory (ROM), or the like, or a storage device such as a hard disk built into a computer system. Further, “computer-readable recording medium” includes a medium that retains a program for a certain period of time such as a volatile memory in a computer system that serves as a server or client when a program is transmitted via a network such as the Internet or a communication line such as a telephone line. The volatile memory may be, for example, a random access memory (RAM). The recording medium may be, for example, a non-transitory recording medium.

Also, the above program may be transmitted from a computer system that stores the program in a storage device or the like to another computer system via a transmission medium or by transmission waves in a transmission medium. Here, the “transmission medium” that transmits the program indicates a medium that has a function of transmitting information, such as a network such as the Internet or a communication line such as a telephone line.

In addition, the above program may be for realizing some of the functions described above. Further, the above program may be a so-called difference file that can realize the above-described functions in combination with a program already recorded in the computer system. The difference file may be called a difference program.

Also, the function of any component (for example, the controller 111) in any device described above may be realized by a processor. For example, each process in the embodiment may be realized by a processor that operates on the basis of information of a program or the like and a computer-readable recording medium that stores information of a program or the like. Here, in the processor, for example, functions of each part may be realized by separate hardware, or functions of each part may be realized by integrated hardware. For example, the processor may include hardware, and the hardware may include at least one of a circuit that processes digital signals and a circuit that processes analog signals. For example, the processor may be configured using one or more circuit devices or one or more circuit elements mounted on a circuit board. An integrated circuit (IC) or the like may be used as the circuit device, and a resistor or a capacitor may be used as the circuit element.

Here, the processor may be, for example, a CPU. However, the processor is not limited to the CPU, and various processors such as a graphics processing unit (GPU) or a digital signal processor (DSP) may be used, for example. Also, the processor may be, for example, a hardware circuit using an application specific integrated circuit (ASIC). Also, the processor may be configured by, for example, a plurality of CPUs, or may be configured by a hardware circuit using a plurality of ASICs. In addition, the processor may be configured by, for example, a combination of a plurality of CPUs and a hardware circuit using a plurality of ASICs. Further, the processor may include, for example, one or more of an amplifier circuit or a filter circuit that processes analog signals.

Although the embodiment of this disclosure has been described above in detail with reference to the drawings, the specific configuration is not limited to the present embodiment and includes designs within the scope of the gist of this disclosure.

[Configuration Example 1] to [Configuration Example 4] will be shown below.

### Configuration Example 1

A switching power supply device including a planar type transformer, wherein a bridge, in which a plurality of switch elements are connected in series, and a primary winding are provided on a primary side of the transformer, and the switch elements include the switch elements controlled by a first on time, and the switch elements controlled by a second on time different from the first on time.

### Configuration Example 2

The switching power supply device according to [Configuration Example 1], wherein two secondary windings having a center tap configuration are provided on a secondary side of the transformer.

### Configuration Example 3

The switching power supply device according to [Configuration Example 1] or [Configuration Example 2], wherein the transformer has an air gap located at an asymmetrical position.

### Configuration Example 4

The switching power supply device according to any one of [Configuration Example 1] to [Configuration Example 3], wherein the first on time and the second on time are set in accordance with a predetermined index value on the basis of correspondence between the first on time and the second on time and the index value.

### EXPLANATION OF REFERENCES

1 Switching power supply device
11 DC power supply
12, 63 Capacitor
13 Inductor
14 Primary winding
61, 62 Secondary winding
64 Load
111 Controller
131 Memory
211 Printed circuit board
231 to 232 Core member
261 to 262, 271 to 272 Winding pattern
A1, A2, A11 to A12, A21 to A22 Control voltage

B1 to B2, B11 to B12, B101 to B102, B111 to B112, B121 to B122, B131 to B132, B141 to B142, B151 to B152, B201 to B202, B211 to B212, B221 to B222, B301 to B302, B311 to B312, C1 to C2, C11 to C12, C101, C102, C111 to C112, C121 to C122, C131 to C132, C141 to C142, C151 to C152, C201 to C202, C211 to C212, C221 to C222, C301 to C302, C311 to C312 Current
1011 Variable correction table
D1, D2 diode
H1 Air gap
J1 Core
Q1, Q2 Transistor
G1, G2 Ground portion
Tr1 Transformer

What is claimed is:

1. A switching power supply device comprising:
a planar type transformer,
wherein a bridge, in which a plurality of switch elements are connected in series, and a primary winding are provided on a primary side of the transformer, and
the switch elements include the switch elements controlled by a first on time, and the switch elements controlled by a second on time different from the first on time.

2. The switching power supply device according to claim 1,
wherein two secondary windings having a center tap configuration are provided on a secondary side of the transformer.

3. The switching power supply device according to claim 1,
wherein the transformer has an air gap located at an asymmetrical position.

4. The switching power supply device according to claim 1,
wherein the first on time and the second on time are set in accordance with a predetermined index value on the basis of correspondence between the first on time and the second on time and the index value.
